(19) United States
(12) Patent Application Publication
(10) Pub. No.: US 2009/0146789 A1
(43) Pub. Date: Jun. 11, 2009

(54) Vehicle occupant protection device

(75) Inventors: Wolfgang Holbein, Alfdorf (DE); Stefan Zimmer, Weinstadt (DE); Valentin Maier, Gmuend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 12/315,284

(22) Filed: Dec. 2, 2008

(30) Foreign Application Priority Data
Dec. 4, 2007 (DE) 10 2007 058 277.5

(51) Int. Cl. H04Q 5/22

(52) U.S. Cl. 340/10.1

(57) ABSTRACT

A vehicle occupant protection device includes a safety-relevant means which can assume at least two different conditions. The vehicle occupant protection device further comprises a reading device (12) including an antenna (13), and a transponder (10) which, in dependence on the respective condition of the safety-relevant means or in dependence on a change in condition, produces a characteristic reaction detectable by the reading device (12). A coupling means (30) is arranged between the antenna (13) of the reading device (12) and the transponder (10). The coupling means (30) collects, diverts and again emits at least part of the energy emitted by the antenna (30) of the reading device (12).

### TECHNICAL FIELD

This invention relates to a vehicle Occupant protection device, comprising a safety-relevant means which can assume at least two different conditions.

### BACKGROUND OF THE INVENTION

From DE 100 37 260 A1 a vehicle occupant protection device comprising a safety-relevant means which can assume at least two different conditions is known. The device further comprises a reading device including an antenna, and a transponder which, in dependence on the respective condition of the safety-relevant means or in dependence on a change in condition, produces a characteristic reaction detectable by the reading device. By means of a transponder mounted on a child seat and a vehicle-mounted reading device it is checked, for instance, whether a central belt buckle of the belt system provided for the child seat is closed. For this purpose, the transponder scans the resistance of a circuit, which depends for instance on the condition of a microswitch associated to the belt buckle. In a logic module of the transponder, the resistance is converted into a digital signal and modulated on in the form of a load generated by a switch of the transponder. By means of this so-called load modulation, the electromagnetic field of the reading device is specifically changed, which in turn is detected by the reading device itself. After a corresponding evaluation, the switching condition of the microswitch and hence the locking condition of the central belt buckle can thus be determined.

A similar vehicle occupant protection device is also shown in DE 10 2006 042 455 A1. A belt buckle is equipped with a switch which indicates the insertion condition of a tongue of the safety belt. A means for providing a wireless transmission of the switch position to a receiver circuit is associated to the switch. The means associated to the switch can be an RFID tag.

It is an object of the invention to improve the transmission of energy from a reading device to a transponder of a safety-relevant means in a vehicle occupant protection device.

### BRIEF SUMMARY OF THE INVENTION

According to the invention, a vehicle occupant protection device comprises a safety-relevant means which can assume at least two different conditions. The vehicle occupant protection device further comprises a reading device including an antenna, and a transponder which, in dependence on the respective condition of the safety-relevant means or in dependence on a change in condition, produces a characteristic reaction detectable by the reading device. A coupling means is arranged between the antenna of the reading device and the transponder. The coupling means collects, diverts and again emits at least part of the energy emitted by the antenna of the reading device. The coupling means provided in accordance with the invention ensures that the field emitted by the antenna of the stationary reading device reaches a transponder located outside the normal reach or shielded in an undesired way, without the field strength having to be increased for this purpose. In contrast to known systems, the arrangement of the reading device or its antenna thus is largely independent of the position of the transponder. By the coupling means, the transmission of energy from the reading device to the transponder advantageously is protected against disturbing influences by metal parts, liquids, etc. It is particularly notable that it is not necessary to make any changes on the reading device, in particular on its antenna, or on the transponder, in order to achieve these effects. In so far, well-established and standardized system components can be used, and data transmission as such can be performed according to usual standards (e.g. ISO 14443 or ISO 15693). A transponder and a reading device together with the coupling means generally can be utilized for realizing a condition-specific switch or sensor with regard to the vehicle occupant protection device. Such switch or sensor is almost free from wear, temperature-insensitive and free from influences of moisture.

In a simple form of the coupling means it is provided that the coupling means includes an input antenna for collecting the energy emitted by the antenna of the reading device and an output antenna for emitting the energy collected by the input antenna. The input antenna is arranged near the antenna of the reading device, and the output antenna is arranged near the transponder.

The input antenna and/or the output antenna preferably include a coil.

For actually diverting the energy emitted by the antenna of the reading device, a transmission path preferably formed by a shielded and/or twisted cable is provided between the input antenna and the output antenna.

In accordance with an advancement of the invention, a plurality of transponders are provided, and the coupling means includes a plurality of output antennas. In this way, the energy can be diverted to a plurality of transponders, which are all associated to the same reading device.

In a first variant of this advancement, the transmission path includes branches to the output antennas. In this case, only one input antenna is provided in the coupling means.

In a second variant of the advancement, the coupling means includes a plurality of input antennas and a plurality of transmission paths, which each extend between an input antenna and an output antenna.

The characteristic reaction of the transponder in a change in condition preferably is caused by specifically covering or shielding the transponder against the energy emitted by the output antenna of the coupling means. The invention makes use of the finding that a characteristic reaction of the transponder can be caused by specific changes of an electric or magnetic field in the region of influence (detection range) of the transponder. Thus, by switching on, switching off or otherwise changing an electric or magnetic field in dependence on a current condition or a change in condition of the vehicle occupant protection device, the “consumption” of the energy of the electromagnetic field of the reading device can be changed. The reading device will register this change and thus can indicate the current condition or the change in condition.

Another possibility of causing a characteristic reaction detectable by the reading device consists in that the transponder specifically is moved outside the reach of the energy emitted by the output antenna.

In accordance with a particularly preferred application of the invention, the safety-relevant means of the vehicle occupant protection device includes a belt buckle, and the transponder is mounted on the belt buckle. With only minor modifications of a conventional belt buckle, the current locking condition can be obtained by means of the transponder and a magnet (in the case of a change in the magnetic field) or a metal part (in the case of a change in the electric field), which in the case of a change in the locking condition is moved relative to the transponder. Additional circuits with microswitches or the like no longer are required. Inside the belt buckle, several possibilities exist for mounting the transponder and the magnet or metal part in accordance with the invention.

### BRIEF DESCRIPTION OF THE DRAWINGS

FIG. 1 schematically shows the basic structure of a transponder system;

FIG. 2 shows a transponder system for a vehicle occupant protection device of the invention in accordance with a first embodiment;

FIG. 3 shows a transponder system for a vehicle occupant protection device in accordance with a second embodiment; and

FIG. 4 shows a transponder system for a vehicle occupant protection device in accordance with a third embodiment.

### DETAILED DESCRIPTION OF THE PREFERRED EMBODIMENTS

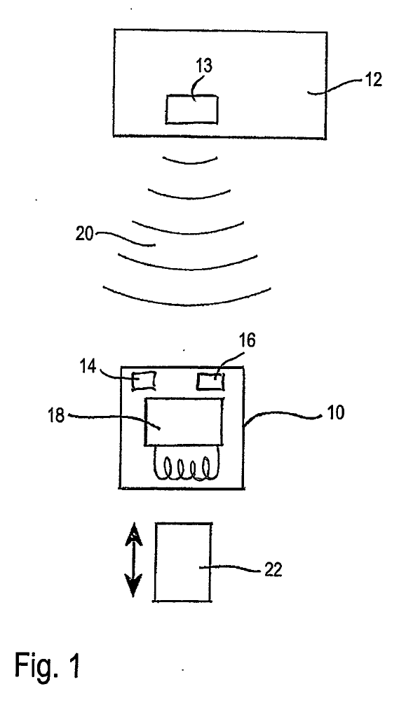

FIG. 1 shows the basic structure of a transponder system, more precisely of an RFID system, which can be used for a safety belt system according to the invention. The system comprises a transponder 10 in the form of an RFID tag and a reading device 12 (RFID reader) adjusted to this transponder 10 with an antenna 13. The transponder 10 includes a transponder antenna 14 (coil), a microchip 16 and an inductive unit 18, which is part of a high-frequency oscillating circuit.

Normally, an RFID communication works as follows: In regular intervals, the reading device 12 generates an electromagnetic field 20, which is emitted by the antenna 13 of the reading device 12 and received by the transponder antenna 14. As soon as the transponder antenna 14 gets close to the electromagnetic field 20, an induction current is generated in the transponder antenna 14 (inductive coupling). This induction current activates the microchip 16. The microchip 16 receives commands from the reading device 12, and thereupon the transponder 10 modulates responses into the field 20 emitted by the reading device 12. The transponder 10 itself does not emit a field, but only changes the electromagnetic field 20 of the reading device 12, in that it “consumes” energy of the field 20 in a characteristic way, which in turn is detected by the reading device 12.

In dependence on the operating frequency, a distinction is made between different types of transponders 10. HF tags employ load modulation, i.e. they consume part of the energy of the field 20 by short-circuiting. Due to the inductive coupling in the near electromagnetic field, exciting the tag exclusively works in the short range. Therefore, the antenna 14 of an HF tag is an induction coil in the form of a resonance coil with several windings. UHF tags, however, operate in the far electromagnetic field for transmitting the response by a backscattering method. Here, the field 20 of the reading device 12 either is absorbed (short circuit) or reflected with a rather large reflecting cross-section (mirror). The antenna 14 of an UHF tag mostly is a dipole antenna.

The responses of the transponder 10 additionally are specifically influenced by means of a high-frequency circuit and a “field changing means”, e.g. in the form of a magnet or metal part. Strictly speaking, detuning of the oscillating circuit, i.e. a change of the resonance frequency, in the transponder 10 produces a reaction which can be detected by the reading device 12. Detuning is generated by specifically covering or shielding the inductive unit 18 accommodated in the transponder 10, preferably by a metal part 22. By using suitable trigger thresholds in the traversed frequency range, a distinction can thus be made between at least two conditions. When the change of the field acting on the transponder 10 correlates with a change in condition of a safety-relevant means of a vehicle occupant protection device, the reading device 12 can detect the change in condition and communicate the same e.g. to a control unit of a vehicle occupant protection device.

Alternatively, the reaction of the transponder 10 characteristic for a change in condition also can be caused in that the transponder 10, which previously was within reach of the reading device 12, deliberately is moved outside this reach in the case of a change in condition, or vice versa. In this case, the reading device 12 constitutes a kind of sensor, which can indicate the presence/absence of the transponder 10 (and of a component or carrier connected therewith) in the range of detection of the reading device 12. The transponder 10 used can also have an interface to an elementary sensor of the vehicle occupant protection device.

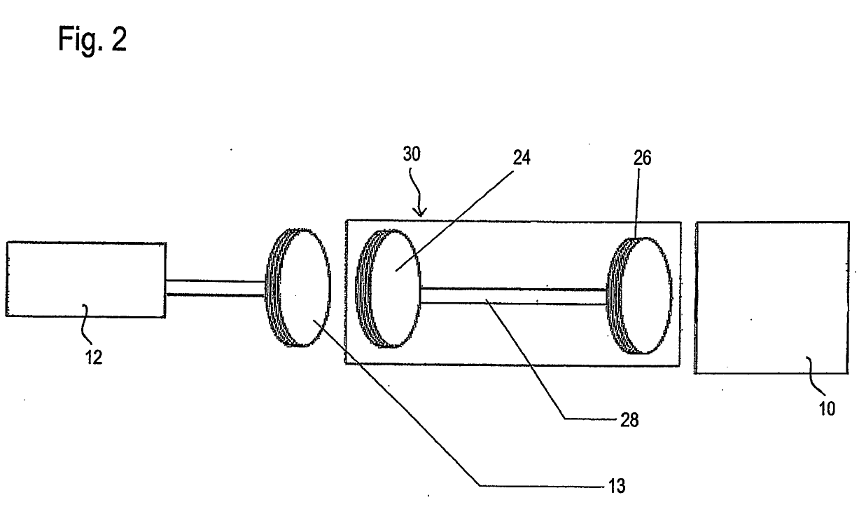

FIG. 2 illustrates the structure of a transponder system for a vehicle occupant protection device of the invention in accordance with a first embodiment. In the vicinity of the antenna 13 of the reading device 12, an input antenna 24 in the form of a coil is arranged. In the vicinity of the transponder 10 an output antenna 26 likewise in the form of a coil is arranged. Between the input antenna 24 and the output antenna 26, a transmission path 28 is formed by a shielded and/or twisted cable. Contrary to the schematic representation of FIG. 2, the transmission path 28 can have any course that can be realized with a suitable cable. The input antenna 24, the output antenna 26 and the transmission path 28 together form a coupling means 30 for the specific transmission of the field 20 emitted by the antenna 13 of the reading device 12 to the transponder.

The operation of the coupling means 30 can be described as follows. The input antenna 24 collects at least part of the energy emitted by the antenna 13 of the reading device 12. Via the transmission path, the energy collected is diverted to the output antenna 26 and again emitted by the same. The transponder antenna 14 finally receives the field emitted by the output antenna 26, which substantially is unchanged with respect to the field 20 emitted by the antenna 13 of the reading device 12.

How far the input antenna 24 can be away from the antenna 13 of the reading device 12 and the output antenna 26 from the transponder 10 depends on the field strength of the field 20 emitted by the antenna 13 of the reading device 12. In any case, it is important that the input antenna 24 is closer to the antenna 13 of the reading device 12 than the output antenna 26 and that the output antenna 26 is closer to the transponder 10 than the input antenna 24.

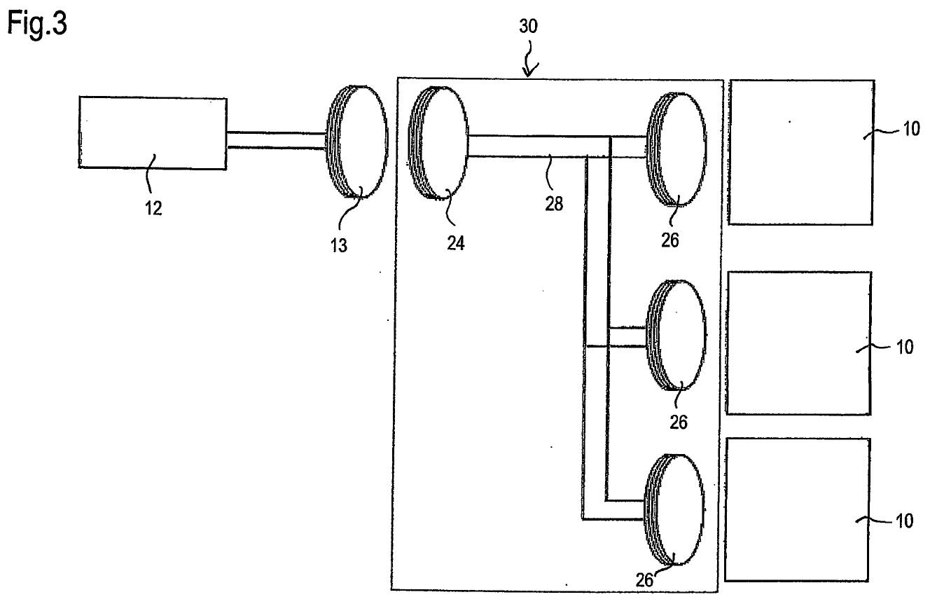

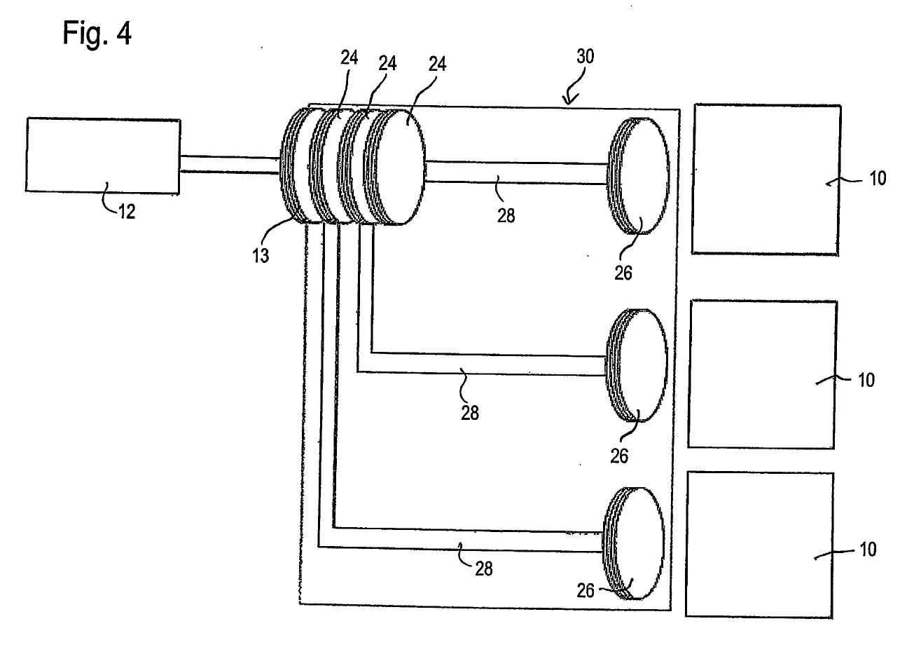

FIGS. 3 and 4 show two modifications of the coupling means for the case that several, preferably differently coded transponders 10 are associated to a single reading device 12. For the components known from the first preferred embodiment, the same reference numerals are used.

As shown in FIG. 3, the transmission path 28 is branched. Each branch leads to an output antenna 26, which is associated to a particular transponder 10.

The variant as shown in FIG. 4 differs therefrom in that for each transponder 10 a separate input antenna 26, a separate transmission path 28 and an output antenna 26 associated to the respective transponder 10 are provided, with each input antenna 26 collecting part of the field 20 emitted by the antenna 13 of the reading device 12.

For the above-described cases that several transponders 10 are used with only one reading device 12, a priorization of the different transponders 10 can be achieved by changing one of the standardized RFID anticollision methods (e.g. binary search algorithm).

Preferred applications of the invention include, for instance:
determination of the position of a belt height adjuster (transponder 10 mounted on the belt height adjuster),
determination the seating position and the seat inclination angle (transponder 10 mounted on the seat or backrest),
detection of a folded seat (transponder 10 mounted on the backrest),
determination of the position of a headrest (transponder 10 mounted on the headrest),
detection of a folded condition (folded up or down) of a sun vizor (transponder 10 mounted on the sun vizor),
detection of a closing condition (open or closed) of a door, a trunk or a hood (transponder 10 mounted on the door, on the trunk or on the hood),
determination of the position of a safety belt and/or the belt extension length in a safety belt system (transponder 10 mounted on the safety belt),
occupant classification via a child safety mechanism of a belt retractor (transponder 10 mounted on the safety belt),
determination of the position of an insertion tongue on a safety belt (transponder 10 mounted on the safety belt, preferably on a limit stop for the insertion tongue, or on the insertion tongue).

In all applications, one or more transponders 10 can be used in conjunction with a single reading device 12.

As already mentioned, it should be noted for all embodiments that it is not absolutely necessary to produce a characteristic reaction of the transponder 10 by specifically influencing the transponder 10, but it can also be provided that generally in the case of a change in condition of the vehicle occupant protection device the transponder 10 is moved into or out of the range of detection of the reading device 12. The reading device 12 detects the presence or absence of the transponder 10, so that the current condition of the vehicle occupant protection device can be determined.

For all applications, 1-bit transponders (occasionally also referred to as 0-bit transponders) or other commonly used tags can also be provided in principle instead of RFID tags. 1-Bit transponders, which are known e.g. from goods protection systems, produce a change in the field 20, such as reflecting the field 20 on another frequency or short-circuiting the field 20, etc.

In the LF range, so-called electromagnetic transponders can be used. Such transponder is designed as a magnetically soft amorphous metal strip, which has a steep hysteresis curve. There can also be used an acoustomagnetic transponder, which likewise causes a change in the field 20. In the HF range, a change in the field 20 can be effected in two different ways, namely by incorporating a tag configured as an LC oscillating circuit or as a frequency divider. In the UHF range, 1-bit transponders are designed such that they generate an nth harmonic of the fundamental wave of the field 20. This can be effected by means of a dipole antenna, which is short-circuited via a capacitance diode.

1. A vehicle occupant protection device, comprising
a safety-relevant means which can assume at least two different conditions, a reading device including an antenna, and
a transponder which, in dependence on the respective condition of the safety-relevant means or in dependence on a change in condition, produces a characteristic reaction detectable by the reading device, a
coupling means being arranged between the antenna and the transponder, the coupling means collecting, diverting and again emitting at least part of an energy emitted by the antenna of the reading device.

2. The vehicle occupant protection device according to claim 1, wherein the coupling means includes an input antenna for collecting the energy emitted by the antenna of the reading device and an output antenna for emitting the energy collected by the input antenna, the input antenna being arranged near the antenna of the reading device, and the output antenna being arranged near the transponder.

3. The vehicle occupant protection device according to claim 2, wherein at least one of the input antenna and the output antenna includes a coil.

4. The vehicle occupant protection device according to claim 2, wherein between the input antenna and the output antenna a transmission path is formed by at least one of a shielded and a twisted cable.

5. The vehicle occupant protection device according to claim 2, wherein a plurality of transponders are provided and the coupling means includes a plurality of output antennas.

6. The vehicle occupant protection device according to claim 5, wherein the transmission path includes branches to the output antennas.

7. The vehicle occupant protection device according to claim 5, wherein the coupling means includes a plurality of input antennas and a plurality of transmission paths, each transmission path extending between an input antenna and an output antenna.

8. The vehicle occupant protection device according to claim 1, wherein the characteristic reaction of the transponder is caused by specifically covering or shielding the transponder against an energy emitted by the output antenna.

9. The vehicle occupant protection device according to claim 1, wherein the characteristic reaction of the transponder is caused by moving the transponder outside the reach of an energy emitted by the output antenna.

10. The vehicle occupant protection device according to claim 1, wherein the safety-relevant means includes a belt buckle and the transponder is mounted on the belt buckle.

11. The vehicle occupant protection device according to claim 1, wherein the transponder includes an RFID tag and the reading device includes an RFID reader.
